(19) United States
(12) Patent Application Publication
(10) Pub. No.: US 2005/0246953 A1
(43) Pub. Date: Nov. 10, 2005

(54) Coated planting cotton seed and a process for its manufacture

(76) Inventor: Tom Wedegaertner, Raleigh, NC (US)

Correspondence Address: LESLIE GLADSTONE RESTAINO;BROWN RAYSMAN MILLSTEIN & STEINER LLP, 163 MADISON AVENUE, PO BOX 1989, MORRISTOWN, NJ, 07962-1989, US

(21) Appl. No.: 10/843,234

(22) Filed: May 10, 2004

(51) Int. Cl. A01C 1/06

(52) U.S. Cl. 47/57.6

(57) ABSTRACT

The present invention relates to a cotton seed suitable for planting and the process of making the same. The polymer coating allows the cotton seed to be used in conventional seed planting handling equipment.

### FIELD OF THE INVENTION

The present invention relates generally to a cotton seed composition comprising a polymer coating to adapt it for use with planting seed handling equipment, and a process for applying the coating to the cotton seed.

### BACKGROUND OF THE INVENTION

As used herein, the seed used for producing planting cotton seed is referred to as “cottonseed” or “seed.” The term “cottonseed,” “seed of cotton,” “seed” and “cotton seed,” as used herein, can be singular or plural and refer to the individual component of the commodity referred to by the singular, collective term “cottonseed.”

Planting cotton seeds are produced in large quantities as a byproduct of cotton cultivation and commercialization. After the cotton has been picked from the boll of the cotton plant, it is processed through a gin which separates the seeds from the cotton fibers. The cotton seed as it comes out of a gin is covered with a thin coating of residual cotton fibers, commonly known in the art as “linters” or “fuzz,” which gives the cotton seed a fuzzy appearance, and results in the nomenclature, “linter-bearing cotton seed” or “fuzzy cotton seed.” The protruding linters on cotton seeds have a strong tendency to intermingle with the linters of neighboring seeds, causing the seeds to entangle and clump together, resulting in poor flowability and handleability. Moreover, the linter-bearing cotton seed also has other undesirable physical characteristics such as a very low bulk density, which creates problems for processing, transporting, and storing processes. There is a need in the art to produce planting cotton seeds which can be handled by conventional planting seed processing equipment.

Generally, seeds for use as planting seeds are characterized by high quality, high cost, and low volume. Therefore, a high cost per unit volume for improving the flow characteristics may be acceptable for producing planting seeds.

Most of the processes of the art for improving the flow characteristic of cotton seed involve removal of the linters by mechanical means, chemical means, or by singeing. Coles, et al., in U.S. Pat. Nos. 5,204,102 and 5,363,754, teach coated cotton seed with improved flow characteristic and the apparatus to produce the same. Specifically, Coles, et al., teaches delinting the cotton seed by singeing before coating and the use of a “binder” and a “filler” to form a coating on the cotton seed. However, this process produces a somewhat burnt seed that may have been exposed to excess heat, thereby reducing its suitability for uses as planting seed. Furthermore, the flame process results in the need for additional coating materials because the flamed linters do not readily accept the coating materials.

U.S. Pat. No. 5,750,466 discloses a process of coating linter-bearing cotton seed with starch and one or more biologically related materials, such as vitamins, feed supplements, oils, fats, ores, rodent repellants, insect repellants, medications, antigermination agents and preservatives.

U.S. Pat. No. 5,972,414 teaches a process of treating cotton seed to improve its handleability, which comprises the steps of: (a) adjusting the pH to equal or less than three of an aqueous composition having a sugar concentration of at least five percent by weight; and (b) applying the aqueous composition to whole cotton seed; or (a) applying an aqueous sugar composition having a sugar concentration to of at least five percent by weight to the whole cotton seed; and (b) applying an acidic aqueous solution having a pH equal to or less than three to the whole cotton seed. U.S. Pat. No. 6,051,269 provides a similar process except that the pH of the composition is adjusted to equal or greater than eight.

Summer, et al., in U.S. patent application Nos. 2002/0098226 (the '226 application) and 2003/0049363 (the '363 application) teaches a method for preparing a handleable, flowable coated cotton seed product by coating cotton seed with a composition of (a) water or a liquid feed product, (b) a soluble phosphorous source and (c) a metal compound capable of interacting with the soluble phosphorous source to form a coating on the cotton seed, and curing the coating formed thereby (the '226 application), or (a) water or a liquid feed product, (b) one or more organic acids and (c) a metal compound capable of interacting with the one or more organic acids to form a coating on the cotton seed, and curing the coating formed thereby (the '363 application). Nevertheless, the coated cotton seed product of these processes has excess number of seeds with tails and non-durable coatings and is not suitable for use in commercial cotton planters.

It would be desirable to provide coated cotton seed for particular use as a planting seed with flow characteristics that allow it to be handled and transported by conventional equipment.

### SUMMARY OF THE INVENTION

The present invention provides a polymer-coated planting cotton seed, wherein the polymer-coated planting cotton seed is produced by applying a coating composition to a cotton seed, wherein the coating composition comprises a polymer and the temperature of the coating composition is lower than 75° C.; and drying the polymer-coated cotton seed. In one aspect, the coating polymer is gelatinized starch. Preferably, the gelatinized starch is applied in more than one coating, wherein each coating comprises at least 3% starch. The coating composition may further comprise at least one additive. The desired temperature for the coating composition is ambient temperature.

In one aspect, the cotton seed is a linter-bearing cotton seed. For planting seed production, it is desirable to regin the linter-bearing cotton seed prior to the coating step. Preferably, the linter-bearing cotton seed is reginned using an abrasive surface.

The present invention further provides a planting seed composition comprising the polymer-coated cotton seed.

In another aspect, the present invention provides a process for preparing a polymer-coated planting cotton seed, comprising applying a coating composition to a cotton seed, wherein the coating composition comprises a polymer and the temperature of the coating composition is lower than 75° C.; and drying the polymer-coated cotton seed. The process may further comprise storing the polymer-coated planting cotton seed. The desired temperature for the coating composition is ambient temperature.

Additional aspects of the present invention will be apparent in view of the description which follows.

### BRIEF DESCRIPTION OF THE FIGURE

FIG. 1 is a flow chart illustrating the steps of the process of the present invention for preparing coated cotton seed.

### DETAILED DESCRIPTION OF THE INVENTION

As used herein, the singular forms “a,” “an” and “the” include plural references unless the content clearly dictates otherwise.

Before the start of the coating process, cotton seed is first removed from the raw seed cotton, i.e., as it comes from the boll of the cotton plant, in the ginning operation. In one embodiment, the cotton seed used as the starting material in the present process has previously had most of the staple-length lint removed. In another embodiment, the cotton seed used as the starting material is a linter-bearing seed.

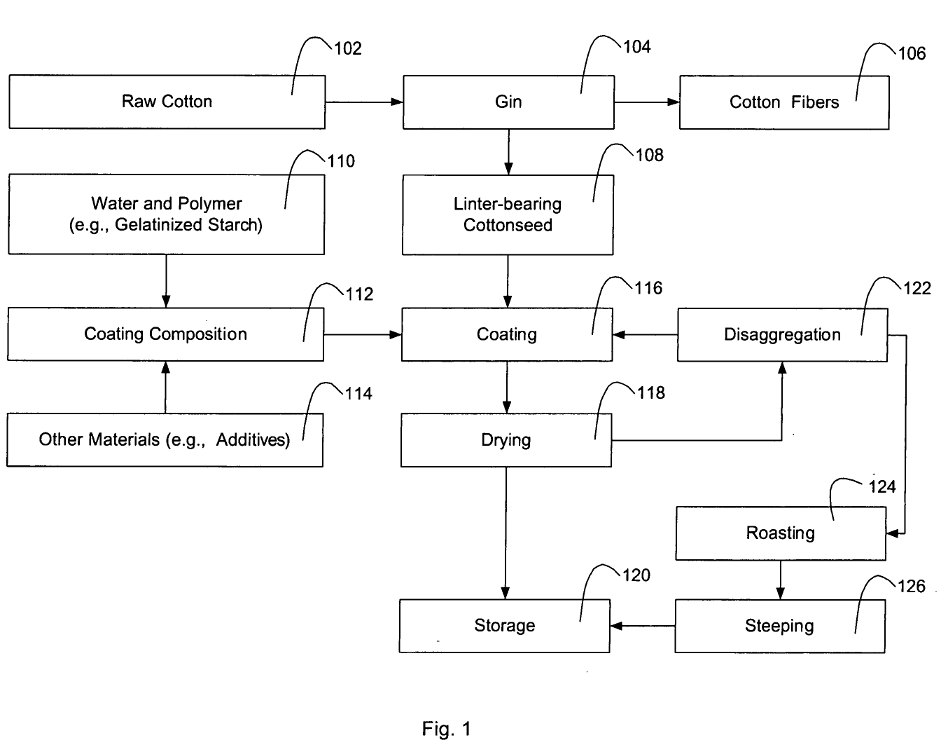

Referring to FIG. 1, before the start of the coating process, linter-bearing cotton seed 108 is first removed from the raw seed cotton 102 in the ginning operation 104. The cotton seed 108 used as the starting material in the present process has previously had most of the lint 106 removed. Optionally, the linter-bearing cotton seed is further cleaned/reginned or partially reginned (process 124). During the coating process 116, the cotton seed 108 is coated with the coating composition 112 comprising water and a coating polymer 110 (such as pre-gelatinized starch) and optionally, other materials 114 (such as additives). The materials 114 may also be applied directly to the cotton seed during the coating process 116. The polymer-coated cotton seed is substantially dried during the drying process 118. Clumps of coated seeds may be formed during the coating 116 and drying 118 processes. These clumps may be disaggregated by passing the coated cotton seed through at least one beater, or simply removed. The optional disaggregation process 122 may be a single or multi-step process and may be performed consecutively or concurrently with the drying process. The separated cotton seeds, optionally, may be subjected to another round(s) of coating 116 and drying 118 processes preferable for producing planting seed. Finally, the polymer-coated planting cotton seed is put into storage 120 before use.

In one aspect, a cotton seed is reginned or cleaned, i.e., reducing the fuzz on the cotton seed, prior to the subsequent steps. This process is desirable or, in certain circumstances, essential for producing planting seed. Cotton seed that is coated without being properly reginned may result in the generation of “grape clusters” and other entanglements that are not suitable for uses as planting seed. Further, the amount of materials required to coat a cotton seed appropriately is generally proportional to the amount of linters remaining on the seed. Therefore, cotton seed with less fuzz requires less coating (i.e., consuming less materials, energy, time and other resources) to achieve desired coating results. As a specific example, cotton seed with about 12% residual linters requires approximately 6% coating, whereas cotton seed that has been partially delinted to 3% residual linters requires only a 1.5% coating. A cotton seed may be cleaned using any gin apparatus which is suitable for cleaning cotton seed. In one embodiment, a cotton seed is mechanically cleaned using an apparatus including, but not limited to, the gin apparatus disclosed in U.S. Pat. No. 6,061,875. Compared to those cleaned by flame, cotton seeds prepared using mechanical cleaning need less coating materials to achieve the same coating result and the coated product has improved visual appeal. In another embodiment, the mechanical cleaning machine uses an abrasive surface to remove the linters from cotton seed rather than using a rotating saw.

In one aspect, the cotton seed is sprayed with a coating composition comprising a coating polymer to coat, preferably uniformly coat, the cotton seed with the polymer coating composition. The thickness of the coating is a function of four major factors: a) the viscosity of the polymer composition, b) the concentration of the polymer, c) the time period the seeds are being sprayed with the composition, and d) the speed the coating composition is applied. Each of these factors can be manipulated to adjust the thickness of the coating.

Although gelatinized starch is the preferred coating material, it is understood in the art that other polymers may also be used for coating planting cotton seed including, but not limited to, starch, modified starch, polyvinyl alcohol, various sugars and other water soluble polymers. Gelatinized starch from a variety of sources may be used for the present invention. For example, gelatinized potato, wheat and corn starches or mixtures thereof are acceptable. Therefore, the choice of starch and other polymers depends on its availability as well as economic considerations. Polymers which are not suitable for coating livestock feed cotton seed because of cost and/or toxicity may be used for coating planting seed. Preferably, the polymers are water-soluble and can be applied without heat.

As discussed in U.S. Pat. No. 5,750,466, the inventor has disclosed the using of hot (>75° C.), gelatinized starch to coat cotton seed. While it is appropriate for producing livestock feed, the composition and process may have detrimental effects on a cotton seed used for producing planting seed, reducing the rate of germination. Therefore, it is desirable to have the temperature of the coating polymer composition, such as a gelatinized starch composition, to be about 10-75° C., preferably, 15-60° C., and more preferably, 18-35° C. There are circumstances that, in order to prepare the coating polymer composition, the coating polymer and other components of the composition need to be heated to a temperature above 75° C. It is desirable that the heat-treated coating polymer composition be cooled to a suitable temperature lower than 75° C. In a preferred embodiment, the temperature of the coating composition is ambient temperature.

An alternative approach is to add water or aqueous solutions to the cotton seed and then apply the coating polymer composition, to the wet seed. In one embodiment, the coating polymer composition may be applied in the dry powder form or pre-gel form.

The coating polymer composition may be prepared in a vessel, such as a starch cooking vessel, equipped with means for stirring and, optionally, heating, the composition. It is known in the art that, when preparing a coating polymer composition, the polymer and water may be mixed in a certain range of proportions, in a certain sequence, and in a certain temperature range to obtain a smooth and uniform solution. For example, a starch suspensions may be prepared following methods disclosed in Theory and Practice of Textile Slashing, 1st Ed., Monograph No. 1, Auburn University, Auburn, Ala. (1972), to obtain a smooth and uniform gelatinized suspension. The starch solution preferred for the process of the present invention is about 2% to about 20% starch by weight and is heated at a temperature from about 76° C. to boiling with stirring until it is gelatinized. In another embodiment, pre-gelatinized starch may be used to prepare the coating composition and therefore eliminates the need for cooking equipment. It will be appreciated by those skilled in the art that a gelatinized starch composition may be prepared by a batch or continuous process.

The essential ingredients of the coating polymer composition are polymer (e.g., gelatinized starch or other film forming polymer) and water, but one or more additives such as, but not limited to, fertilizers, vitamins, oils, fats, proteins, trace elements, ground cereal grains, hormones, urea, anti-fungal agents, antibiotic agents, rodent repellants, insect repellants, medications, germination control agents, preservatives, metal compounds (such as, sulfate salts, carbonate salts, halide salts, oxide salts, hydroxide salts, propionate salts, acetate salts, alkaline earth metal salts, diatomaceous earth, clay, talc and aluminum salts), may be added to enhance the properties of the coated cotton seed. For example, a coating might contain a fertilizer plus an anti-fungal agent to provide enhanced seedling vigor. Furthermore, small quantities of surfactants, e.g., wetting agents, may be added to the coating polymer composition to promote uniform and durable coating. The optional ingredients can be added anytime during the coating composition preparation. In one embodiment, the additives are added to the coating composition just before the application on the cotton seed or during agitation of the sprayed cotton seed.

Fillers are not essential components of the coating although, in certain circumstance, they are included to improve the quality of the coated seeds and/or facilitate the coating process. Traditional methods for coating cotton seed involve first putting a binder on the seed and then subsequently adding fillers on the seed. Nevertheless, a large amount of fillers, about 40% by weight to the total weight of the coated seed, has to be used to achieve an acceptable coating following the traditional methods. The present invention provides a coating method which requires significant less fillers to be used in the coating process to achieve an appropriate coating than the traditional coating method. According to the method of the present invention, fillers (such as, but not limited to, limestone, bentonite, talc or magnesium oxide), if needed, are added to the gelatinized starch solution or other coating polymer composition. The polymer-filler mixture is subsequently applied to cotton seed in need of coating. For example, the inventor demonstrated that gelatinized starch with less than 2% talc (by weight) achieves an acceptable coating. In one embodiment, fillers may also be added to the coating composition for improving the physical and/or chemical properties of the coating and the coated cotton seed rather than simply as a “filler.”

The polymer (e.g., starch) coated cotton seed is substantially dried including, but not limited to, by air or hot air. Conveniently, this can be carried out by passing air over and/or through a bed of coated seeds as they are moved through a drying chamber. The rate of drying can be controlled by the temperature of the air, the rate of flow of the air and the speed of movement of the seeds. These factors may be adjusted to achieve an optional coating, that is the coating of the cotton seed as it leaves the drying chamber is hard but not brittle or flaky. Preferably, the coating should be dried so that the moisture level is between about 3% and about 20% and, more preferably, between about 7% and about 11%.

For producing planting seed, a rotary type dryer is preferred. In a rotary dryer, cotton seeds with residual lint tend to aggregate and form “grape clusters.” This allows the dryer to serve as a sorting machine for seeds containing excess residual lint because grape clusters are easily removed from the finished product. In a preferred embodiment, cotton seed coated for planting seed purpose may be dried in lower temperature for a longer period of time than those conditions used in drying animal feed.

Optionally, clumps of coated seeds may be broken up, i.e., disaggregated, by passing the coated cotton seed through one or more beaters. The disaggregation may be a single or multi-step process and may be performed consecutively or concurrently with the drying process. The beaters may be of any configuration known in the art for disaggregating of coated goods, such as counter rotating drums with projecting spikes that pull the aggregated coated seeds apart. Alternatively, a series of beaters may be placed in the drying chamber. In one embodiment, a screening step, instead of or in combination of the disaggregation step, may be performed to separate clumps from the rest of the coated cotton seed. A variety of screening methods, such as density-based screening as well as air fractionation, are commonly known in the art.

In one aspect, the coated seeds are allowed to cool to ambient temperature, and then placed in storage. It is desirable to keep the stored coated planting cotton seed in a dry condition and to protect it from temperature extremes.

The degree of coating is between 3% and about 50%, preferably, between about 4% and about 30% and, more preferably, between about 5% and about 10% of the weight of the coated planting cotton seed (on the basis of dry polymer (e.g., starch) and dry cotton seed). However, some specialized applications may require very thin or extra thick coatings, such as when several optional ingredients are included in the coating.

It is understood that applying multiple, thinner coatings rather than a single, thick coating may be advantageous for some applications. Multiple, thin applications of a coating composition, such as pre-gelatinized starch, yield a hard coat that can withstand rough handling and long storage and are preferred for coated cotton seed to be used as planting seed. In one embodiment, the seeds are coated and dried for two or multiple rounds. The same coating materials may be used in different coating cycles. In one embodiment, each round of coating process uses a different coating material. Optionally, the seeds may be sorted and screened prior to another round of coating. In one embodiment, the seed is dried or partially dried before the subsequent round of coating process. For example, the inventors demonstrated that planting cotton seeds with better coating qualities may be obtained through using two rounds of “light” coating (3-5% pre-gelatinized starch) than using a single round of “heavy” coating (6%). However, the application of a single, thick coating consumes less energy and resources than the application of multiple thinner coatings and the resulting thick single-layer coated cotton seed is acceptable for many applications.

The coated cotton seed prepared using the process of the present invention may be useful as planting seed. Where the polymer-coated cotton seed is to be used as planting seed, multiple, thin coating is preferred because the cotton seed has coat that is sufficiently durable to be handled using mechanized planting equipment.

### EXAMPLES

The following examples illustrate the present invention, which are set forth to aid in the understanding of the invention and should not be construed to limit in any way the scope of the invention as defined in the claims which follow thereafter.

### Example 1

### Preparation of 2000 Kg Batch of Coated Planting Cotton Seed

A gelatinized starch solution is prepared by adding gelatinized starch (64 Kg) and water (450 L) into a starch cooker equipped with a stirrer. The starch and water are stirred to form a starch solution. The gelatinized starch solution is then introduced into a storage tank, where it is stored before the coating step.

Before applying the cotton seed to the seed hopper for coating, the linter-bearing cotton seed is reginned mechanically so that the cotton seed does not contain excessive amount of lint or linters. The reginned cotton seed in batches of about 250 Kg is charged into a seed hopper from which it is moved by a series of metering wheels, into a mixing chamber above which is a series of spraying nozzles. As the hopper is depleting, more cotton seed is added until all of the 2000 kg has been placed in the hopper. The gelatinized starch solution, fed from the storage tank, is forced out by a pump through the spraying nozzles onto the cotton seed that is being agitated in the mixing chamber by a mixing auger. The gelatinized starch solution is added at a rate so that the entire batch is applied uniformly to the 2000 Kg of cotton seed. (This rate of application may be determined by calculation or experimentally using pilot batches.) As the mixing auger moves the cotton seed with random rotation through the mixing chamber, the cotton seed is sprayed from above by the spraying nozzles. The seeds are also rolled in the solution collected in the bottom of the mixing chamber.

The coated cotton seed is moved out of the mixing chamber and transferred into a rotary dryer. During the approximate 15 minutes the coated seeds are transient in the drying chamber, hot air (about 50° C. to about 100° C.) is passed through the chamber.

During the coating and drying processes, the coated seeds tend to aggregate together. The coated seeds then drop onto a sloping, sorter screen having a mesh sized so that single coated seeds pass through while coated seeds that are aggregated slide across the top of the screen. The screened coated seeds drop onto a conveyor and cool to near ambient temperature as they are being transported to a storage container. The starch coating ranges from about 2% to about 5% of the weight of the dried, coated cotton seed.

### Example 2

### Preparation of 2000 Kg Batch of Double Coated Planting Cotton Seed

The coated planting cotton seed is prepared in a similar manner as in Example 1 except that 128 Kg starch and 1200 L of water are used to prepare the gelatinized starch solution. Furthermore, the rate of application of the suspension is adjusted so that about one half of the solution is applied on the 2000 Kg of cotton seed. After all the cotton seeds have been coated and dried, they are screened and returned to the seed hopper and coated and dried again. The starch coating ranges from about 4% to about 11% of the weight of the dried, coated cotton seed.

### Example 3

### Preparation of 2000 Kg of Coated Planting Cotton Seed With the Coating Containing a Nutritional Supplement

The coated planting cotton seed is prepared as in Example 1 except that, just before transfer from the cooker to the storage tank, 50 Kg of starter fertilizer containing a seedling disease control agent and 1.0 Kg of USDA approved red coloring is blended into the gelatinized starch solution. The coated cotton seed product is nutritionally enhanced and protected against damage from pests and is colored red so that it can be identified as such. Alternatively, the starter fertilizer containing the seedling disease control agent and coloring are added at the point of starch application without pre-mixing.

The planting cotton seed processed as described in Examples 1-3 is superior to cotton seed processed by traditional methods.

While the foregoing invention has been described in some detail for purposes of clarity and understanding, it will be appreciated by one skilled in the art, from a reading of the disclosure, that various changes in form and detail can be made without departing from the true scope of the invention in the appended claims.

1. A cotton seed suitable for planting which is produced by:
a) applying a coating composition comprising at least one polymer to the cotton seed, wherein the temperature of the coating composition is lower than 75° C.; and
b) drying the coated cotton seed.

2. The cotton seed of claim 1, wherein the at least one polymer is gelatinized starch.

3. The cotton seed of claim 1, wherein the coating composition comprises about 2% to about 20% gelatinized starch by weight.

4. The cotton seed of claim 3, wherein the starch coating is about 4% to about 11% by weight on a dry basis.

5. The cotton seed of claim 1, wherein the coating composition further comprises at least one filler.

6. The cotton seed of claim 5, wherein the amount of the at least one filler is about 1% to 20% by weight on a dry basis relative to the weight of the coated cotton seed.

7. The cotton seed of claim 5, wherein the at least one filler composition is talc.

8. The cotton seed of claim 7, wherein the amount of talc is at least about 1% by weight on a dry basis relative to the weight of the coated cotton seed.

9. The cotton seed of claim 1, wherein the coating composition further comprises at least one additive.

10. The cotton seed of claim 9, wherein the at least one additive is fertilizer, anti-fungal agent, or both.

11. The cotton seed of claim 1, wherein at least one additive is applied to the cotton seed after step a).

12. The cotton seed of claim 1, wherein the temperature of the coating composition is ambient temperature.

13. The cotton seed of claim 1, wherein the cotton seed is a linter-bearing cotton seed.

14. The cotton seed of claim 13, wherein the linter-bearing cotton seed is reginned before the step a).

15. The cotton seed of claim 1, wherein water or aqueous solution is applied to the cotton seed before the step a).

16. The cotton seed of claim 1, wherein the coated cotton seed is dried using a rotary type dryer.

17. The cotton seed of claim 1, wherein the steps a) and b) are repeated at least one time.

18. The cotton seed of claim 17, wherein the starch coating is at least about 3% by weight on a dry basis.

19. The cotton seed of claim 18, wherein the starch coating is about 4% to about 11% by weight on a dry basis.

20. The cotton seed of claim 17, wherein the coating composition used in the step a) is a different coating composition from the coating composition used in the step a) of the subsequent cycle.

21. A composition comprising the planting cotton seed of claim 1.

22. A cotton seed suitable for planting which is produced by:
a) mechanically reginning a linter-bearing cotton seed;
b) applying a coating composition comprising at least one polymer to the cotton seed, wherein the temperature of the coating composition is lower than 75° C.; and
c) drying the coated cotton seed.

23. The cotton seed of claim 22, wherein the at least one polymer is gelatinized starch.

24. The cotton seed of claim 22, wherein the coating composition comprises about 2% to about 20% gelatinized starch by weight.

25. The cotton seed of claim 24, wherein the starch coating is about 4% to about 11% by weight on a dry basis.

26. The cotton seed of claim 22, wherein the coating composition further comprises at least one filler.

27. The cotton seed of claim 26, wherein the amount of the at least one filler is about 1% to 20% by weight on a dry basis relative to the weight of the coated cotton seed.

28. The cotton seed of claim 26, wherein the at least one filler composition is talc.

29. The cotton seed of claim 28, wherein the amount of talc is at least about 1% by weight on a dry basis relative to the weight of the coated cotton seed.

30. The cotton seed of claim 22, wherein the coating composition further comprises at least one additive.

31. The cotton seed of claim 30, wherein the at least one additive is fertilizer, anti-fungal agent, or both.

32. The cotton seed of claim 22, wherein at least one additive is applied to the cotton seed after step b).

33. The cotton seed of claim 22, wherein the temperature of the coating composition is ambient temperature.

34. The cotton seed of claim 22, wherein the linter-bearing cotton seed is reginned using an abrasive surface.

35. The cotton seed of claim 22, wherein water or aqueous solution is applied to the cotton seed before the step b).

36. The cotton seed of claim 22, wherein the coated cotton seed is dried using a rotary type dryer.

37. The cotton seed of claim 22, further comprising cleaning or screening the coated cotton seed after step c).

38. The cotton seed of claim 22, further comprising storing the coated cotton seed.

39. The cotton seed of claim 22, wherein the steps b) and c) are repeated at least one time.

40. The cotton seed of claim 39, wherein the starch coating is at least 3% by weight on a dry basis.

41. The cotton seed of claim 40, wherein the starch coating is about 4% to about 11% by weight on a dry basis.

42. A composition comprising the planting cotton seed of claim 22.

43. A process for preparing a cotton seed suitable for planting, comprising:
a) applying a coating composition comprising at least one polymer to the cotton seed, wherein the temperature of the coating composition is lower than 75° C.; and
b) drying the coated cotton seed.

44. The process of claim 43, wherein the at least one polymer is gelatinized starch.

45. The process of claim 43, wherein the coating composition comprises about 2% to about 20% gelatinized starch by weight.

46. The process of claim 43, wherein the coating composition further comprises at least one additive.

47. The process of claim 43, wherein at least one additive is applied to the cotton seed after the step a).

48. The process of claim 43, wherein the temperature of the coating composition is ambient temperature.

49. The process of claim 43, wherein the cotton seed is a linter-bearing cotton seed.

50. The process of claim 49, wherein the linter-bearing cotton seed is reginned before the step a).

51. The process of claim 43, wherein water or aqueous solution is applied to the cotton seed before the step a).

52. The process of claim 43, wherein the coated cotton seed is dried using a rotary type dryer.

53. The process of claim 43, wherein the steps a) and b) are repeated at least one time.

54. The process of claim 53, wherein the coating composition used in the step a) is a different coating composition from the coating composition used in the step a) of the subsequent cycle.

55. The process of claim 43, further comprising storing the coated cotton seed.

56. A process for preparing a cotton seed suitable for planting, comprising:
a) mechanically reginning a linter-bearing cotton seed;
b) applying a coating composition comprising at least one polymer to the cotton seed, wherein the temperature of the coating composition is lower than 75° C.; and
c) drying the coated cotton seed.

57. The process of claim 56, wherein the linter-bearing cotton seed is reginned using an abrasive surface.
